(19) United States
(12) Patent Application Publication
(10) Pub. No.: US 2015/0312123 A1
(43) Pub. Date: Oct. 29, 2015

(54) METHOD AND APPARATUS FOR ISOLATING A FAULT IN A CONTROLLER AREA NETWORK

(71) Applicants: Yilu ZHANG, Northville, MI (US); Xinyu DU, Oakland Township, MI (US); Mutasim A. SALMAN, Madison, WI (US); Tsai-Ching LU, Wynnewood, PA (US); David L. ALLEN, Thousand Oaks, CA (US); Shengbing JIANG, Rochester Hills, MI (US)

(72) Inventors: Yilu ZHANG, Northville, MI (US); Xinyu DU, Oakland Township, MI (US); Mutasim A. SALMAN, Madison, WI (US); Tsai-Ching LU, Wynnewood, PA (US); David L. ALLEN, Thousand Oaks, CA (US); Shengbing JIANG, Rochester Hills, MI (US)

(21) Appl. No.: 14/425,116

(22) PCT Filed: Sep. 5, 2012
(86) PCT No.: PCT/US12/53725

§ 371 Date: Jul. 13, 2015

(51) Int. Cl. H04L 12/26; H04L 29/08

(52) U.S. Cl. CPC H04L 43/0847; H04L 43/0817; H04L 67/12

(57) ABSTRACT

A controller area network (CAN) has a plurality of CAN elements including a communication bus and controllers. A method for monitoring the controller area network CAN includes identifying active and inactive controllers based upon signal communications on the communication bus and identifying a candidate fault associated with one of the CAN elements based upon the identified inactive controllers.

### TECHNICAL FIELD

This disclosure is related to communications in controller area networks.

### BACKGROUND

The statements in this section merely provide background information related to the present disclosure. Accordingly, such statements are not intended to constitute an admission of prior art.

Vehicle systems include a plurality of subsystems, including by way of example, engine, transmission, ride/handling, braking, HVAC, and occupant protection. Multiple controllers may be employed to monitor and control operation of the subsystems. The controllers can be configured to communicate via a controller area network (CAN) to coordinate operation of the vehicle in response to operator commands, vehicle operating states, and external conditions. A fault can occur in one of the controllers that affects communications via a CAN bus.

Known CAN systems employ a bus topology for the communication connection among all the controllers that can include a linear topology, a star topology, or a combination of star and linear topologies. Known high-speed CAN systems employ linear topology, whereas known low-speed CAN systems employ a combination of the star and linear topologies. Known CAN systems employ separate power and ground topologies for the power and ground lines to all the controllers. Known controllers communicate with each other through messages that are sent at different periods on the CAN bus. Topology of a network such as a CAN network refers to an arrangement of elements. A physical topology describes arrangement or layout of physical elements including links and nodes. A logical topology describes flow of data messages or power within a network between nodes employing links.

Known systems detect faults at a message-receiving controller, with fault detection accomplished for the message using signal supervision and signal time-out monitoring at an interaction layer of the controller. Faults can be reported as a loss of communications. Such detection systems generally are unable to identify a root cause of a fault, and are unable to distinguish transient and intermittent faults. One known system requires separate monitoring hardware and dimensional details of physical topology of a network to effectively monitor and detect communications faults in the network.

### SUMMARY

A controller area network (CAN) has a plurality of CAN elements including a communication bus and controllers. A method for monitoring the controller area network CAN includes identifying active and inactive controllers based upon signal communications on the communication bus and identifying a candidate fault associated with one of the CAN elements based upon the identified inactive controllers.

### BRIEF DESCRIPTION OF THE DRAWINGS

One or more embodiments will now be described, by way of example, with reference to the accompanying drawings, in which:

FIG. 1 illustrates a vehicle including a controller area network (CAN) including a CAN bus and a plurality of nodes, e.g., controllers, in accordance with the disclosure;

FIG. 2 illustrates an inactive controller detection process for monitoring a CAN, in accordance with the disclosure;

FIG. 3 illustrates a controller isolation process for isolating a physical location of a fault in a CAN including a CAN bus, a power grid and a ground grid, in accordance with the disclosure;

FIG. 4 illustrates a system setup process for characterizing a CAN, in accordance with the disclosure;

FIGS. 5-1 through 5-5 illustrate a CAN including controllers, a monitoring controller and communications links associated with operation of an embodiment of the fault isolation process, in accordance with the disclosure;

FIG. 6 illustrates a CAN including a plurality of controllers signally connected to a CAN bus and electrically connected to a power grid and a ground grid associated with operation of an embodiment of the fault isolation process, in accordance with the disclosure; and

FIG. 7 illustrates an alternate embodiment of a method for identifying a candidate fault set in a CAN as part of a fault isolation process, in accordance with the disclosure.

### DETAILED DESCRIPTION

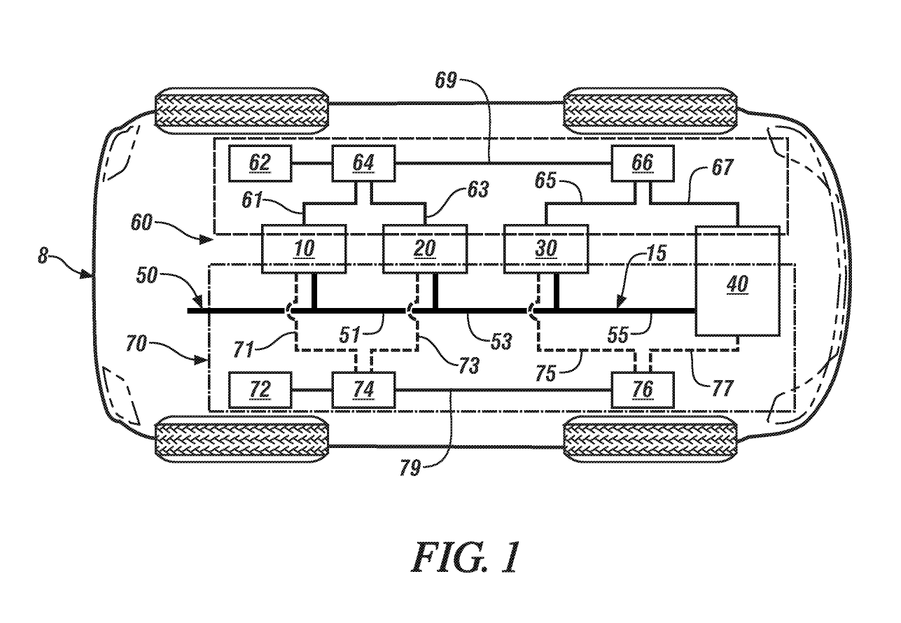

Referring now to the drawings, wherein the showings are for the purpose of illustrating certain exemplary embodiments only and not for the purpose of limiting the same, FIG. 1 schematically shows a vehicle 8 including a controller area network (CAN) 50 including a CAN bus 15 and a plurality of nodes, i.e., controllers 10, 20, 30 and 40. The term “node” refers to any active electronic device that signally connects to the CAN bus 15 and is capable of sending, receiving, and/or forwarding information over the CAN bus 15. Each of the controllers 10, 20, 30 and 40 signally connects to the CAN bus 15 and electrically connects to a power grid 60 and a ground grid 70. Each of the controllers 10, 20, 30 and 40 includes an electronic controller or other on-vehicle device that is configured to monitor and/or control operation of a subsystem of the vehicle 8 and communicate via the CAN bus 15. In one embodiment, one of the controllers, e.g., controller 40 is configured to monitor the CAN 50 and the CAN bus 15, and may be referred to herein as a CAN controller. The illustrated embodiment of the CAN 50 is a non-limiting example of a CAN, which may be employed in any of a plurality of system configurations.

The CAN bus 15 includes a plurality of communications links, including a first communications link 51 between controllers 10 and 20, a second link communications 53 between controllers 20 and 30, and a third communications link 55 between controllers 30 and 40. The power grid 60 includes a power supply 62, e.g., a battery that electrically connects to a first power bus 64 and a second power bus 66 to provide electric power to the controllers 10, 20, 30 and 40 via power links. As shown, the power supply 62 connects to the first power bus 64 and the second power bus 66 via power links that are arranged in a series configuration, with power link 69 connecting the first and second power buses 64 and 66. The first power bus 64 connects to the controllers 10 and 20 via power links that are arranged in a star configuration, with power link 61 connecting the first power bus 64 and the controller 10 and power link 63 connecting the first power bus 64 to the controller 20. The second power bus 66 connects to the controllers 30 and 40 via power links that are arranged in a star configuration, with power link 65 connecting the second power bus 66 and the controller 30 and power link 67 connecting the second power bus 66 to the controller 40. The ground grid 70 includes a vehicle ground 72 that connects to a first ground bus 74 and a second ground bus 76 to provide electric ground to the controllers 10, 20, 30 and 40 via ground links. As shown, the vehicle ground 72 connects to the first ground bus 74 and the second ground bus 76 via ground links that are arranged in a series configuration, with ground link 79 connecting the first and second ground buses 74 and 76. The first ground bus 74 connects to the controllers 10 and 20 via ground links that are arranged in a star configuration, with ground link 71 connecting the first ground bus 74 and the controller 10 and ground link 73 connecting the first ground bus 74 to the controller 20. The second ground bus 76 connects to the controllers 30 and 40 via ground links that are arranged in a star configuration, with ground link 75 connecting the second ground bus 76 and the controller 30 and ground link 77 connecting the second ground bus 76 to the controller 40. Other topologies for distribution of communications, power, and ground for the controllers 10, 20, 30 and 40 and the CAN bus 15 can be employed with similar effect.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any controller executable instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 3.125, 6.25, 12.5, 25 and 100 milliseconds during ongoing engine and vehicle operation. Alternatively, routines may be executed in response to occurrence of an event.

Each of the controllers 10, 20, 30 and 40 transmits and receives messages across the CAN 50 via the CAN bus 15, with message transmission rates occurring at different periods for different ones of the controllers. A CAN message has a known, predetermined format that includes, in one embodiment, a start of frame (SOF), an identifier (11-bit identifier), a single remote transmission request (RTR), a dominant single identifier extension (IDE), a reserve bit (r0), a 4-bit data length code (DLC), up to 64 bits of data (DATA), a 16-bit cyclic redundancy check (CDC), 2-bit acknowledgement (ACK), a 7-bit end-of-frame (EOF) and a 3-bit interframe space (IFS). A CAN message can be corrupted, with known errors including stuff errors, form errors, ACK errors, bit 1 errors, bit 0 errors, and CRC errors. The errors are used to generate an error warning status including one of an error-active status, an error-passive status, and a bus-off error status. The error-active status, error-passive status, and bus-off error status are assigned based upon increasing quantity of detected bus error frames, i.e., an increasing bus error count. Known CAN bus protocols include providing network-wide data consistency, which can lead to globalization of local errors. This permits a faulty, non-silent controller to corrupt a message on the CAN bus 15 that originated at another of the controllers. A faulty, non-silent controller is referred to herein as a fault-active controller.

A communications fault leading to a corrupted message on the CAN bus 15 can be the result of a fault in one of the controllers 10, 20, 30 and 40, a fault in one of the communications links of the CAN bus 15 and/or a fault in one of the power links of the power grid 60 and/or a fault in one of the ground links of the ground grid 70.

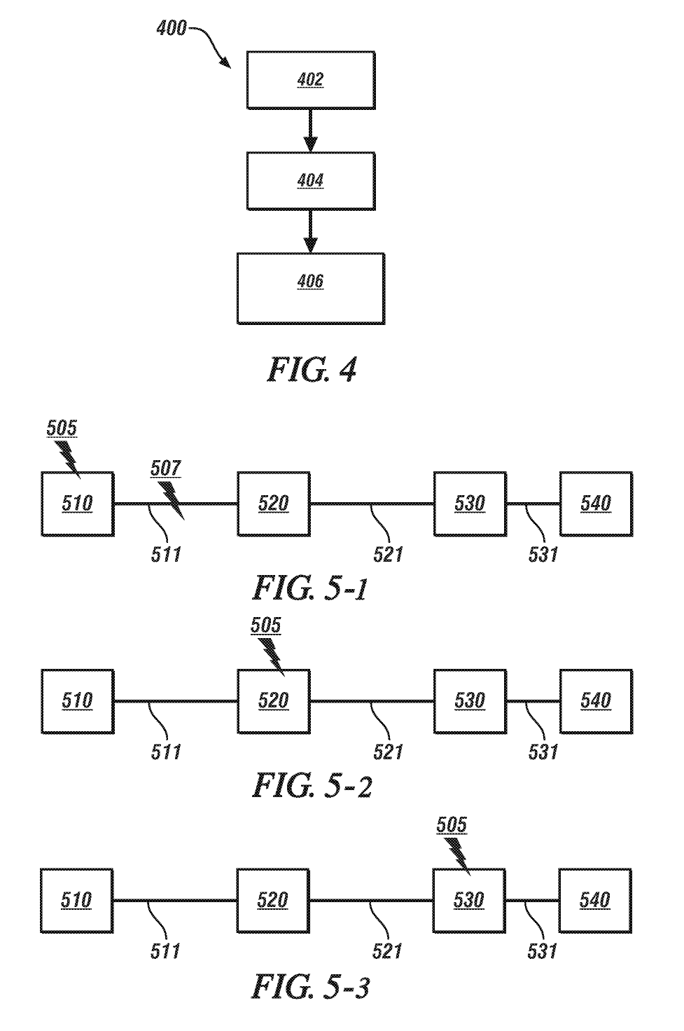

FIG. 4 schematically shows a system setup process 400 for characterizing a CAN, e.g., the CAN 50 depicted with reference to FIG. 1. The resulting CAN characterization is employed in a CAN fault isolation scheme, e.g., the controller isolation process described with reference to FIG. 3. The CAN can be characterized by modeling the system, identifying faults sets, and identifying and isolating faults associated with different fault sets. Preferably, the CAN is characterized off-line, prior to on-board operation of the CAN during vehicle operation. Table 1 is provided as a key to FIG. 4, wherein the numerically labeled blocks and the corresponding functions are set forth as follows.

TABLE 1

| BLOCK | BLOCK CONTENTS |
|---|---|
| 402 | Generate CAN system model |
| 404 | Identify set of faults f |
| 406 | Identify the set of inactive controllers for each fault f |

The CAN system model is generated (402). The CAN system model includes the set of controllers associated with the CAN, a communication bus topology for communication connections among all the controllers, and power and ground topologies for the power and ground lines to all the controllers. FIG. 1 illustrates one embodiment of the communication bus, power, and ground topologies. The set of controllers associated with the CAN is designated by the vector V_{controller}.

A fault set (F) is identified that includes a comprehensive listing of individual faults (f) of the CAN associated with node-silent faults for the set of controllers, communication link faults, power link open faults, ground link open faults, and other noted faults (404). Sets of inactive and active controllers for each of the individual faults (f) are identified (406). This includes, for each fault (f) in the fault set (F), identifying a fault-specific inactive vector V_{f}^{inactive} that includes those controllers that are considered inactive, i.e., communications silent, when the fault (f) is present. A second, fault-specific active vector V_{f}^{active} is identified, and includes those controllers that are considered active, i.e., communications active, when the fault (f) is present. The combination of the fault-specific inactive vector V_{f}^{inactive} and the fault-specific active vector V_{f}^{active} is equal to the set of controllers V_{controller}. A plurality of fault-specific inactive vectors V_{f}^{inactive} containing inactive controller(s) associated with different link-open faults can be derived using a reachability analysis of the bus topology and the power and ground topologies for the specific CAN when specific link-open faults (f) are present.

By observing each message on the CAN bus and employing time-out values, an inactive controller can be detected. Based upon a set of inactive controllers, the communication fault can be isolated since different faults, e.g., bus wire faults at different locations, faults at different controller nodes, and power and ground line faults at different locations, will affect different sets of inactive controllers. Known faults associated with the CAN include faults associated with one of the controllers including faults that corrupt transmitted messages and silent faults, open faults in communications. Thus, the bus topology and the power and ground topologies can be used in combination with the detection of inactive controllers to isolate the different faults.

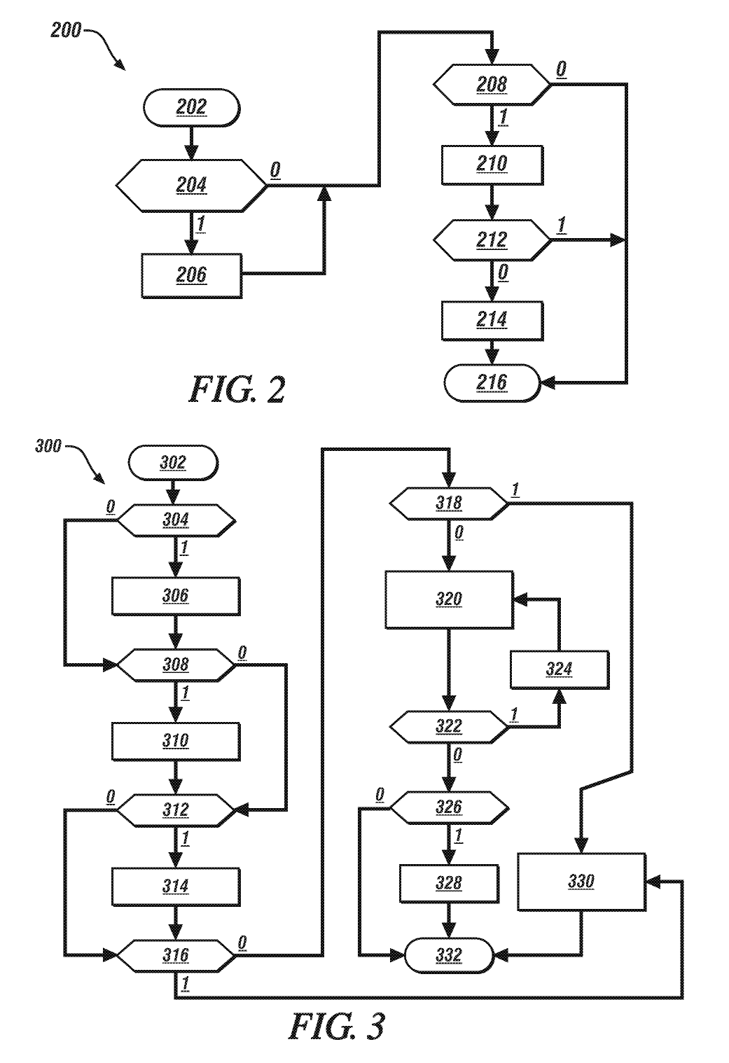

FIG. 2 schematically shows an inactive controller detection process 200, which executes to monitor controller status, including detecting whether one of the controllers connected to the CAN bus is inactive. The inactive controller detection process 200 is preferably executed by a bus monitoring controller, e.g., controller 40 of FIG. 1. The inactive controller detection process 200 can be called periodically or caused to execute in response to an interruption. An interruption occurs when a message is received by the bus monitoring controller, or alternatively, when a supervision timer expires. Table 2 is provided as a key to FIG. 2, wherein the numerically labeled blocks and the corresponding functions are set forth as follows.

TABLE 2

| BLOCK | BLOCK CONTENTS |
|---|---|
| 202 | Start |
| | Monitor CAN messages |
| 204 | Receive message mᵢ from controller Cᵢ? |
| 206 | Activeᵢ = 1 |
| | Inactiveᵢ = 0 |
| | Reset Tᵢ = Thᵢ |
| 208 | Is Tᵢ = 0 for any controller Cᵢ? |
| 210 | For all such controllers Cᵢ: |
| | Activeᵢ = 0 |
| | Inactiveᵢ = 1 |
| 212 | Fault isolation routine triggered? |
| 214 | Set Activeᵢ = 0 for all ECU i; |
| | Set Fault_Num = 1; |
| | Trigger the fault isolation routine |
| 216 | End |

Each of the controllers is designated Cᵢ, with i indicating a specific one of the controllers from 1 through j. Each controller Cᵢ transmits a CAN message and the period of the CAN message mᵢ from controller Cᵢ may differ from the CAN message period of other controllers. Each of the controllers Cᵢ has an inactive flag (Inactiveᵢ) indicating the controller is inactive, and an active flag (Activeᵢ) indicating the controller is active. Initially, the inactive flag (Inactiveᵢ) is set to 0 and the active flag (Activeᵢ) is also set to 0. Thus, the active/inactive status of each of the controllers Cᵢ is indeterminate. A timer Tᵢ is employed for the active supervision of each of the controllers Cᵢ. The time-out value for the supervision timer is Thᵢ, which is calibratable. In one embodiment, the time-out value for the supervision timer is Thᵢ is set to 2.5 times a message period (or repetition rate) for the timer Tᵢ of controller Cᵢ.

The inactive controller detection process 200 monitors CAN messages on the CAN bus (202) to determine whether a CAN message has been received from any of the controllers Cᵢ (204). When a CAN message has not been received from any of the controllers Cᵢ (204)(0), the operation proceeds directly to block 208. When a CAN message has been received from any of the controllers Cᵢ (204)(1), the inactive flag for the controller Cᵢ is set to 0 (Inactiveᵢ=0), the active flag for the controller Cᵢ is set to 1 (Activeᵢ=1), and the timer Tᵢ is reset to the time-out value Thᵢ for the supervision timer for the controller Cᵢ that has sent CAN messages (206). The logic associated with this action is that only active controllers send CAN messages.

When no message has been received from one of the controllers Cᵢ (204)(0), it is determined whether the timer Tᵢ has reached zero for the respective controller Cᵢ (208). If the timer Tᵢ has reached zero for the respective controller Cᵢ (208)(1), the inactive flag is set to 1 (Inactiveᵢ=1) and the active flag is set to 0 (Activeᵢ=0) for the respective controller Cᵢ (210). If the timer Tᵢ has not reached zero for the respective controller Cᵢ (208)(0), this iteration of the inactive controller detection process 200 ends (216). When messages have been received from all the controllers Cᵢ within the respective time-out values Thᵢ for all the supervision timers, inactive controller detection process 200 indicates that all the controllers Cᵢ are presently active. When the supervision timer expires, the inactive controller detection process 200 identifies as inactive those controllers Cᵢ wherein the inactive flag is set to 1 (Inactiveᵢ=1) and the active flag is set to 0 (Activeᵢ=0). It is then determined whether the fault isolation routine has triggered (212). If the fault isolation routine has triggered (212)(1), this iteration of the inactive controller detection process 200 ends (216). If the fault isolation routine has not triggered (212)(0), the active flag is set to 0 (Activeᵢ=0) for all the controllers Cᵢ, i=1, . . . n, the fault count is set (Fault_Num=1) and the fault isolation routine is triggered (214). This iteration of the inactive controller detection process 200 ends (216).

FIG. 3 schematically shows a fault isolation process 300 for isolating a physical location of a fault in one of the CAN bus 15, the power grid 60 and the ground grid 70. The fault isolation process 300 is preferably implemented in and executed by a bus monitoring controller, e.g., controller 40 of FIG. 1, as one or more routines employing calibrations that can be determined during algorithm development and implementation. The fault isolation process 300 is preferably triggered when one of the controllers becomes inactive, e.g., as indicated by the inactive controller detection process 200 of FIG. 2. The fault isolation process 300 subsequently executes periodically until all the controllers Cᵢ are active or otherwise accounted for subsequent to detecting a fault. The routine period is T_{d}, which is a calibratable time wherein T_{d}=min{Thᵢ, i=1, 2, . . . n} wherein Thᵢ represents the time-out threshold for the active supervision of corresponding controller Cᵢ in one embodiment. Table 3 is provided as a key to FIG. 3, wherein the numerically labeled blocks and the corresponding functions are set forth as follows.

TABLE 3

| BLOCK | BLOCK CONTENTS |
|---|---|
| 302 | Start fault isolation process |
| 304 | Activeᵢ = 1 for any of the controllers Cᵢ, i = 1, . . . n |
| 306 | Add all controllers Cᵢ having active flag set to 1 to V_{active} and |
| | remove from V_{inactive} |
| 308 | Inactiveᵢ = 1 for any i? |
| 310 | Add all controllers Cᵢ having inactive flag set to 1 to V_{inactive} |
| | and remove from V_{active} |
| 312 | Any controllers Cᵢ removed from V_{active} and added to |
| | V_{inactive}? |
| 314 | Fault_Num = Fault_Num + 1 |
| | Ft = F_{c} |
| | Set V_{active} to empty |
| | Set Activeᵢ = 0 for all controllers Cᵢ |
| 316 | Any controllers Cᵢ removed from V_{inactive} and added to |
| | V_{active}? |
| 318 | Are all controllers Cᵢ active? |
| 320 | F_{c} = {S ⊂ F\|\|S\| = Fault_ Num |
| | V_{inactive} ⊂ ∪_{f∈S} (V_{f}^{inactive}) |
| | V_{active} ∩ (∪_{f∈S} (V_{f}^{inactive})) = empty |
| | If Ft ≠ empty then ∃R ∈ Ft, R ⊂ S } |
| 322 | Is F = empty and Fault_Num < \|F\|? |
| 324 | Fault_Num = Fault_Num + 1 |
| 326 | Is \|F_{c}\| = 1 or V_{active} ∪ V_{inactive} = V_{controller} |
| 328 | Output F_{c} as the candidate fault set |
| 330 | Set V_{active}, V_{inactive} to empty; |
| | Set Fault_Num = 0 |
| | Stop triggering the fault isolation routine |
| 332 | End |

The fault isolation process 300 includes an active vector V_{active} and an inactive vector V_{inactive} for capturing and storing the identified active and inactive controllers, respectively. The vectors V_{active} and V_{inactive} are initially empty. The Fault_Num term is a counter term that indicates the quantity of multiple faults; initially it is set to zero.

In the case of multiple faults, the candidate(s) of a previously identified candidate fault set are placed in the final candidate fault set. The vector Ft is used to store the previously identified candidate fault set and it is empty initially.

The fault isolation process 300 is triggered by occurrence and detection of a communications fault, i.e., one of the faults (f) of the fault set (F). A single fault is a candidate only if its set of inactive controllers includes all the nodes observed as inactive and does not include any controller observed as active. If no single fault candidate exists, it indicates that multiple faults may have occurred in one cycle. Multiple faults are indicated if one of the controllers is initially reported as active and subsequently reported as inactive.

In the case of multiple faults, a candidate fault set (F_{c}) contains multiple single-fault candidates. The condition for a multi-fault candidate fault set includes that its set of inactive nodes (union of the sets of inactive nodes of all the single-fault candidates in the multi-fault candidate fault set) includes all the nodes observed as inactive and does not include any node observed as active, and at least one candidate from the previous fault is still included in the multi-fault candidate fault set. Once the status of all nodes are certain (either active or inactive) or there is only one candidate, the candidate fault set (F_{c}) is reported out. The candidate fault set can be employed to identify and isolate a single fault and multiple faults, including intermittent faults.

Upon detecting a system or communications fault in the CAN system (302), the system queries whether an active flag has been set to 1 (Activeᵢ=1) for any of the controllers Cᵢ, i=1, . . . n, indicating that the identified controllers are active and thus functioning (304). If the identified controllers are not active and functioning (304)(0), operation skips block 306 and proceeds directly to block 308. If the identified controllers are active and functioning (304)(1), any identified active controller(s) is added to the active vector V_{active} and removed from the inactive vector V_{inactive} (306).

The system then queries whether an inactive flag has been set to 1 (Inactiveᵢ=1) for any of the controllers Cᵢ, i=1, . . . n, indicating that the identified controllers are inactive (308). If the identified controllers are not inactive (308)(0), the operation skips block 310 and proceeds directly to block 312. If the identified controllers are inactive (308)(1), those controllers identified as inactive are added to the inactive vector V_{inactive} and removed from the active vector V_{active} (310).

The system determines whether there have been multiple faults by querying whether any of the controllers have been removed from the active vector V_{active} and moved to the inactive vector V_{inactive} (312). If there have not been multiple faults (312)(0), the operation skips block 314 and proceeds directly to block 316. If there have been multiple faults (312)(1), a fault counter is incremented (Fault_Num=Fault_Num+1) (314), the set Ft used to store the candidates of the previous fault is incorporated into the candidate fault set F_{c} (Ft=F_{c}), the active vector V_{active} is emptied, and the active flags are reset for all the controllers (Activeᵢ=0) (314).

The system determines where a recovery has occurred, thus indicating an intermittent fault by querying whether any of the controllers have been removed from the inactive vector V_{inactive} and moved to the active vector V_{active} (316). If an intermittent fault is indicated (316)(1), the operation proceeds directly to block 330 wherein the active vector V_{active} is emptied, the inactive vector V_{inactive} is emptied, the fault counter Fault_Num is set to 0, and the controller is commanded to stop triggering execution of the fault isolation process 300 (330), and this iteration of the fault isolation process 300 ends (332). If an intermittent fault is not indicated (316)(0), the operation queries whether all the controllers are active (318). If all the controllers are active (318)(1), this iteration of the fault isolation process 300 ends (332). If all the controllers are not active (318)(0), then operation proceeds to block 320.

Block 320 operates to identify the candidate fault set F_{c}, by comparing the inactive vector V_{inactive} with the fault-specific inactive vector V_{f}^{inactive}, and identifying the candidate faults based thereon. FIG. 4 shows an exemplary process for developing a fault-specific inactive vector V_{f}^{inactive}. The candidate fault set F_{c} includes a subset (S) of the fault set (F), wherein the quantity of faults in the subset |S| equals the quantity indicated by the fault counter Fault_Num: (F_{c}=S⊂F∥S|=Fault_Num). The inactive set is a subset that can be expressed as follows.

V_{inactive}⊂∪fεS(V_{f}^{inactive}) [1]

and

V_{active}∩(∪fεS(V_{f}^{inactive}))=empty [2]

Furthermore, if the previous candidate fault set Ft is not empty, then there exists a term R that is an element of the previous fault set Ft, such that R is a subset of set S (320).

The operation queries whether the candidate fault set F_{c} is empty, and whether the fault counter Fault_Num is less than the quantity of all possible faults |F| (322). If so (322)(1), the fault counter Fault_Num is incremented (324), and block 320 is re-executed. If not (322)(0), the operation queries whether the candidate fault set F_{c} includes only a single fault |F_{c}|=1 or whether the combination of the active vector V_{active} and the inactive vector V_{inactive} includes all the controllers (V_{active}ΩV_{inactive}=V_{controller}) (326). If not (326)(0), this iteration of the fault isolation process 300 ends (332). If so (326)(1), the candidate fault set F_{c} is output as the set of fault candidates (328), and this iteration of the fault isolation process 300 ends (332).

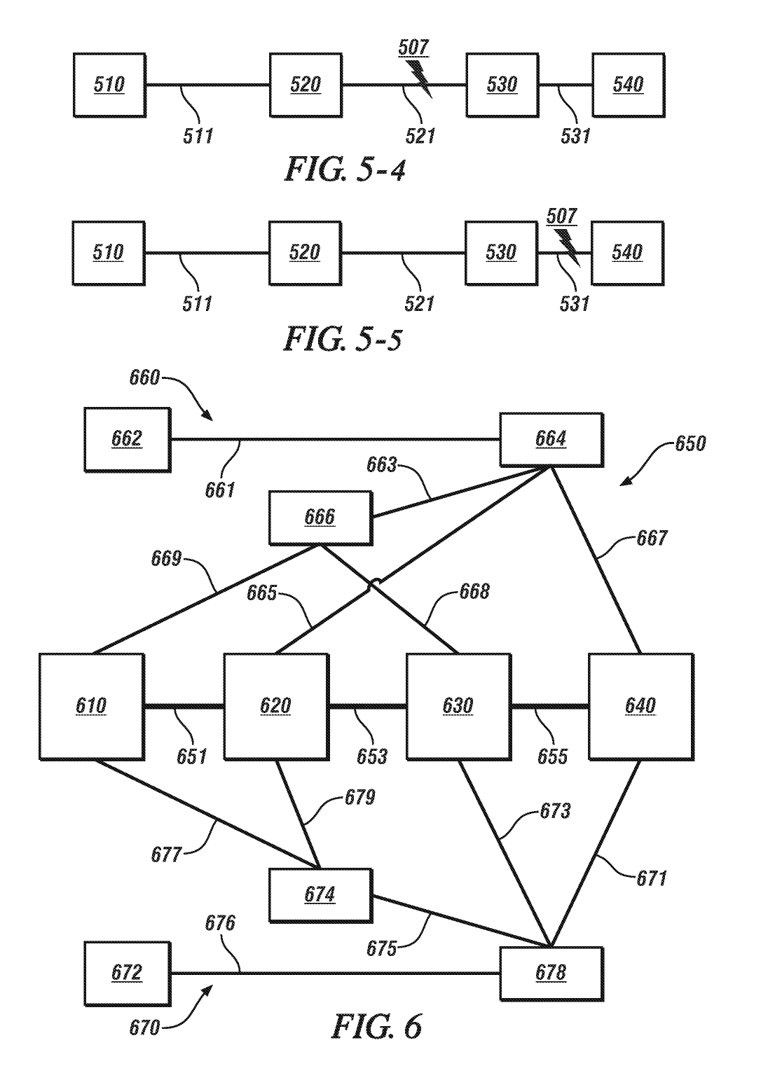

FIGS. 5-1 through 5-5 each schematically shows controllers 510, 520, and 530, monitoring controller 540 and communications links 511, 521, and 531, with related results associated with operation of an embodiment of the fault isolation process 300. As shown in FIG. 5-1, when either or both a node-silent fault 505 is induced in the controller 510 and a link-open fault 507 is induced in the communications link 511, the fault-specific inactive vector V_{f}^{inactive} includes controller 510 and the fault-specific active vector V_{f}^{active} includes controllers 520 and 530. As shown in FIG. 5-2, when a node-silent fault 505 is induced in the controller 520, the fault-specific inactive vector V_{f}^{inactive} includes controller 520 and the fault-specific active vector V_{f}^{active} includes controllers 510 and 530. As shown in FIG. 5-3, when a node-silent fault 505 is induced in the controller 510, the fault-specific inactive vector V_{f}^{inactive} includes controller 530 and the fault-specific active vector V_{f}^{active} includes controllers 510 and 520. As shown in FIG. 5-4, when a link-open fault 507 is induced in the communications link 521, the fault-specific inactive vector V_{f}^{inactive} includes controller 510 and 520, and the fault-specific active vector V_{f}^{active} includes controller 530. As shown in FIG. 5-5, when a link-open fault 507 is induced in the communications link 531, the fault-specific inactive vector V_{f}^{inactive} includes controller 510, 520, and 530, and the fault-specific active vector V_{f}^{active} is empty.

FIG. 6 schematically shows a CAN 650 including a plurality of controllers 610, 620, 630 and 640 signally connected to a CAN bus 615 and electrically connected to a power grid 660 and a ground grid 670. Controller 640 is configured to monitor the CAN 650 and the CAN bus 615. Operation of an embodiment of the fault isolation process 300 is described with reference to the CAN 650. The illustrated embodiment of the CAN 650 is a non-limiting example of a CAN. The CAN bus 615 includes a plurality of communications links, including a first communications link 651 between controllers 610 and 620, a second link communications 653 between controllers 620 and 630, and a third communications link 655 between controllers 630 and 640. The power grid 660 includes a power supply 662, e.g., a battery that electrically connects to a power bus 661 that connects to a first power distribution node 664, which connects via power link 667 to controller 640, via power link 665 to controller 620, and via power link 663 to a second power distribution node 666. The second power distribution node 666 connects via power link 669 to controller 610 and via power link 668 to controller 630. The ground grid 670 includes a vehicle ground 672 that connects via a ground link 676 to a first ground distribution network 678. The first ground distribution network 678 connects via ground link 671 to controller 640, via ground link 673 to controller 630, and via ground link 675 to a second ground distribution network 674. The second ground distribution network 674 connects via ground link 677 to controller 610 and via ground link 679 to controller 620.

When controller 610 is identified as inactive after a single execution of the fault isolation process 300, it indicates that link 651 is open between controllers 610 and 620, or that link 669 is open between controller 610 and power distribution network 666, or that link 677 is open between controller 610 and ground distribution network 674, or that the controller 610 has an internal silent fault.

When controller 620 is identified as inactive after a single execution of the fault isolation process 300, it indicates that link 665 is open between controller 620 and power distribution network 664, or that link 679 is open between controller 620 and ground distribution network 674, or that controller 620 has an internal silent fault.

When controller 630 is identified as inactive after a single execution of the fault isolation process 300, it indicates that link 668 is open between controller 630 and power distribution network 666, or that link 673 is open between controller 630 and ground distribution network 678, or that the controller 630 has an internal silent fault.

When the set of inactive controllers includes controllers 610 and 620, which are identified as inactive after multiple executions of the fault isolation process 300, it indicates that link 653 is open between controller 620 and controller 630, or that link 675 is open between ground distribution network 674 and ground distribution network 678.

When the set of inactive controllers includes controllers 610, 620, and 630, which are identified as inactive after multiple executions of the fault isolation process 300, it indicates that link 655 is open between controller 640 and controller 630, or that there is a wire short in the CAN bus 615.

When the set of inactive controllers includes controllers 610 and 630, which are identified as inactive after multiple executions of the fault isolation process 300, it indicates that link 663 is open between power distribution network 666 and power distribution network 664.

This isolation of faults in the CAN is illustrative. In this manner, the fault isolation process 300 can be employed to isolate a fault to a single location or a limited quantity of locations in the CAN 650.

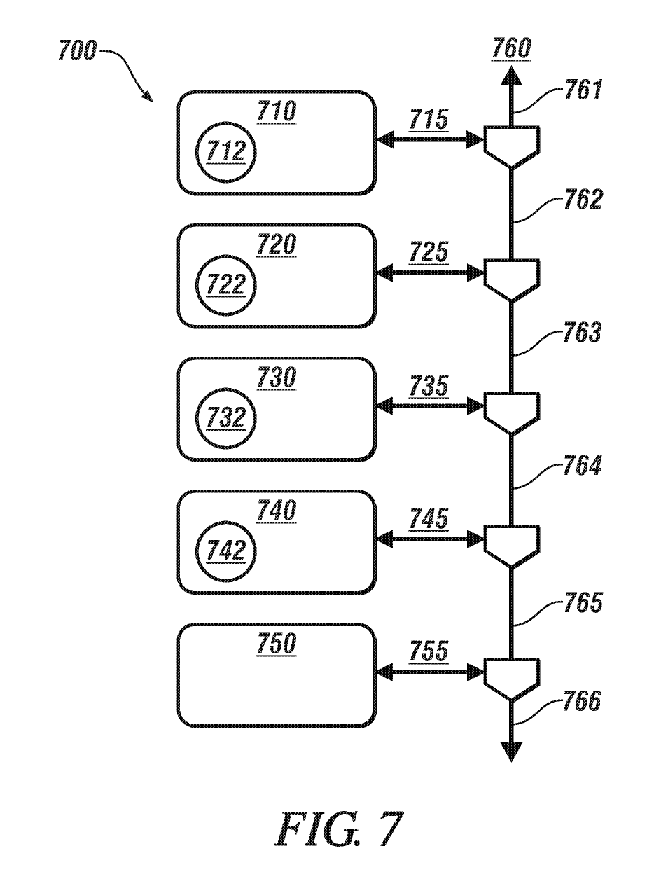

FIG. 7 schematically shows an alternate embodiment of a method for identifying the candidate fault set F_{c}, i.e., Block 320 of the fault isolation process 300, described in relation to CAN 700. The CAN 700 includes controllers 710, 720, 730, and 740, monitoring controller 750, and CAN bus 760. Controller 710 includes software 712 and communications hardware, controller 720 includes software 722 and communications hardware, controller 730 includes software 732 and communications hardware, and controller 740 includes software 742 and communications hardware. Communications link 715 connects the controller 710 to the CAN bus 760, communications link 725 connects the controller 720 to the CAN bus 760, communications link 735 connects the controller 730 to the CAN bus 760, communications link 745 connects the controller 740 to the CAN bus 760, and communications link 755 connects the controller 750 to the CAN bus 760. The CAN bus 760 includes bus links 761, 762, 763, 764, 765, and 766.

Identifying the candidate fault set F_{c} includes generating an off-line model of the CAN. The off-line model identifies all the functional nodes including software and hardware components that are involved in a travel path to transmit a message. Thus, message M1 originates from software 712 in controller 710 and includes controller 710, link 715, bus links 762, 763, 764, and 765, and link 755, and reaches controller 750. Message M2 originates from software 722 in controller 720 and includes controller 720, link 725, bus links 763, 764, and 765, and link 755, and reaches controller 750. Message M3 which originates from software 732 in controller 730 includes nodes including controller 730, link 735, bus links 764 and 765, and link 755, and reaches controller 750. Message M4 originates from software 742 in controller 740 and includes controller 740, link 745, bus link 765 and link 755, and reaches controller 750. The terms S1, S2, S3, and S4 can be employed to represent the sets of nodes including software components, controllers, and communication links involved in the travel paths of transmitting M1, M2, M3, and M4, respectively. That is, S1={712, 710, 715, 762, 763, 764, 765, 755, 750}; S2={722, 720, 725, 763, 764, 765, 755, 750}; S2={732, 730, 735, 764, 765, 755, 750}; S2={742, 740, 745, 764, 765, 755, 750}. The on-line diagnostic monitors the occurrence of each of the messages Mj (j=1, . . . n) within a moving window of period P_{A}, which is based upon a minimum transmission rate for the different controllers. Counting number Nj is associated with each of the messages Mj. When Nj is greater than 1, message Mj is identified as received, or otherwise identified as being lost, and identified as lost message Mₖ. For each lost message Mₖ, the candidate fault set FNSₖ can be identified as those nodes associated with the lost message Mₖ, which is represented by Sₖ, less the nodes associated with all received message(s) Mᵢ during the time period in question, which are represented by Sᵢ. This can be expressed as follows.

FNSₖ=Sₖ−Sₖ∩(∪_{iεReed}Sᵢ) [3]

Thus the candidate fault set FNS is the union of the candidate fault sets associated with each of the lost messages and this can be expressed as follows.

FNS=Ω_{kεLost}FNSₖ [4]

CAN systems are employed to effect signal communications between controllers in a system, e.g., a vehicle. The fault isolation process described herein permits location and isolation of a single fault, multiple faults, and intermittent faults in the CAN systems, including faults in a communications bus, a power supply and a ground network.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for monitoring a controller area network (CAN) including a plurality of CAN elements comprising a communication bus and controllers, comprising:
identifying active and inactive controllers based upon signal communications on the communication bus; and
identifying a candidate fault associated with one of the CAN elements based upon the identified inactive controllers.

2. The method of claim 1, wherein identifying the candidate fault associated with one of the CAN elements comprises:
generating a CAN system model comprising the CAN elements;
identifying a plurality of candidate faults associated with the CAN elements; and
identifying inactive and active controllers for each of the candidate faults based upon the CAN system model.

3. The method of claim 2, wherein identifying the plurality of candidate faults associated with the CAN elements comprises identifying candidate faults associated with the controllers, the communication bus, and a plurality of power links and ground links.

4. The method of claim 3, wherein identifying candidate faults associated with the controllers, the communication bus, and the plurality of power links and ground links comprises identifying node-silent faults for the plurality of controllers, link open faults on the communication bus, power link open faults for the plurality of power links, and ground link open faults for the plurality of ground links.

5. The method of claim 2, wherein identifying inactive controllers for each of the candidate faults based upon the CAN system model comprises identifying controllers that are communications silent when the each of the candidate faults is present based upon the CAN system model.

6. Method for monitoring a controller area network (CAN) including a plurality of CAN elements comprising a communication bus and controllers, comprising:
identifying all functional nodes associated with a plurality of travel paths for transmitting messages from the controllers in the CAN network;
monitoring occurrence of each of the messages and detecting lost ones of the messages and detecting received ones of the messages within a period of time; and
identifying a candidate fault set comprising the functional nodes associated with the travel paths associated with transmitting the lost messages less the functional nodes associated with the travel paths associated with transmitting the received messages.

7. Method for monitoring a controller area network (CAN) including a plurality of nodes signally connected to a communication bus, comprising:
identifying an inactive node based upon signal communications on the communication bus; and
identifying a candidate fault associated with an element of the CAN based upon the inactive node.

8. The method of claim 7, wherein the nodes include electronic devices that signally connect to the communication bus and are configured to send and receive information over the communication bus.

9. The method of claim 7, wherein identifying an inactive node based upon signal communications on the communication bus comprises identifying a node that is communications silent when a candidate fault is present.

10. The method of claim 7, wherein identifying the candidate fault associated with an element of the CAN based upon the inactive node comprises:
generating a system model of the CAN;
identifying a plurality of candidate faults associated with the CAN; and
identifying inactive and active nodes associated with each of the candidate faults based upon the system model of the CAN.

11. The method of claim 10, wherein identifying the plurality of candidate faults associated with the CAN comprises identifying a plurality of candidate faults associated with the nodes, the communication bus, and a plurality of power links and ground links based upon the identified inactive nodes.

12. The method of claim 7, wherein identifying the candidate fault associated with the element of the CAN based upon the inactive node comprises:
generating a system model of the CAN; and
identifying inactive nodes for each of a plurality of candidate faults in the CAN based upon the system model of the CAN.

13. The method of claim 12, wherein identifying inactive nodes for each of the plurality of candidate faults comprises identifying inactive nodes for each of a plurality of node-silent faults for the plurality of nodes.

14. The method of claim 12, wherein identifying inactive nodes for each of the plurality of candidate faults comprises identifying inactive nodes for each of a plurality of power link open faults for each of a plurality of power links.

15. The method of claim 12, wherein identifying inactive nodes for each of the plurality of candidate faults comprises identifying inactive nodes for each of a plurality of ground link open faults for each of a plurality of ground links.

16. The method of claim 12, wherein identifying inactive nodes for each of the plurality of candidate faults comprises identifying inactive nodes for each of a plurality of communications link faults of the for each of a plurality of communication links of the communication bus.
